(19) United States
(12) Patent Application Publication
(10) Pub. No.: US 2011/0310379 A1
(43) Pub. Date: Dec. 22, 2011

(54) APPARATUS AND METHOD FOR MEASURING TERAHERTZ-ABSORPTION CHARACTERISTICS OF SAMPLES

(75) Inventors: Matthew Byrne, Leeds (GB); Edmund Linfield, Leeds (GB); Christopher Wood, Leeds (GB); Alexander Giles Davies, Leeds (GB); John Cunningham, Leeds (GB)

(73) Assignee: UNIVERSITY OF LEEDS, Leeds (GB)

(21) Appl. No.: 13/058,403

(22) PCT Filed: Aug. 5, 2009
(86) PCT No.: PCT/GB2009/050978

§ 371 Date: Jun. 28, 2011

(30) Foreign Application Priority Data
Aug. 11, 2008 (GB) 0814618.5

(51) Int. Cl. G01N 21/25; G01J 3/00

(52) U.S. Cl. 356/51; 356/432

(57) ABSTRACT

A method for measuring an absorption characteristic of a sample comprises: providing a microstrip waveguide comprising a ground plane, an elongate conductive strip having a first end and a second end, and a dielectric substrate separating the ground plane from the elongate strip such that the strip extends from its first end to its second end in a plane substantially parallel to the ground plane; emitting electromagnetic radiation from a first intermediate position along the microstrip waveguide, said first intermediate position being a position between the first and second ends of the strip, such that said radiation propagates along the waveguide in a direction towards the second end; positioning a sample at a position external to the microstrip waveguide and between the first intermediate position and a second intermediate position along the microstrip waveguide, the second intermediate position being a position between the first intermediate position and the second end, such that at least a portion of the sample is exposed to the evanescent electric field of the propagating radiation; and detecting at least one characteristic of the propagating radiation at said second intermediate position. Corresponding apparatus is also disclosed.

### FIELD OF THE INVENTION

The present invention relates to the measurement of absorption characteristics of samples, and in particular, although not exclusively, to apparatus and methods for measuring the Terahertz absorption spectra of materials.

### BACKGROUND TO THE INVENTION

A variety of techniques for measuring absorption characteristics, such as absorption spectra, of various materials are known, for a variety of applications. The ability to measure absorption spectra of samples enables the presence of various materials within those samples to be detected. This has many applications, such as the detection of explosive materials or drugs in security applications, and the detection of the presence of contaminants during or after the manufacture of pharmaceuticals.

Terahertz time-domain spectroscopy (THz-TDS) is routinely used to measure the spectral absorption features of polycrystalline materials across the frequency range from tens of GHz to several THz. In conventional free-space THz-TDS systems, broadband pulsed terahertz radiation is typically generated by sub-picosecond-duration current transients using a photoconductive switch; this radiation is then focused onto and transmitted through a sample, before being detected coherently at a second photoconductive switch, or at an electro-optic crystal. Free-space THz-TDS has allowed detection of vibrational modes in a wide variety of crystalline and poly-crystalline compounds, with typical system bandwidths in excess of several THz (see ref [1] below). Samples should be sufficiently thick to produce a measurable interaction, while still allowing a detectable portion of the terahertz signal to be transmitted. It has recently been shown that THz spectroscopic absorption resonances can also be recorded using low-loss free-standing metal wire waveguides [2], and by parallel plate waveguides [3,4]. In these studies, the waveguide acts to confine the propagating electric field, and increase its interaction with samples.

Problems associated with the prior art spectroscopy techniques include the fact that they have typically required relatively large sample volumes and that their frequency resolution has been limited (for example as a result of the detector being influenced by a reflection, or indeed multiple reflections, rather than it just detecting the electromagnetic radiation that has propagated through or past the sample).

### SUMMARY OF THE INVENTION

It is an aim of certain embodiments of the invention to solve, mitigate or obviate, at least partly, at least one of the problems and/or disadvantages associated with the prior art.

It is an aim of certain embodiments to provide apparatus and methods for measuring one or more absorption characteristics of the sample, which require smaller sample volumes than prior art techniques.

It is an aim of certain embodiments to provide apparatus and methods for measuring absorption spectra of samples, and in particular the Terahertz absorption spectra of samples, with improved frequency resolution compared to the prior art.

According to a first aspect of the present invention, there is provided apparatus for measuring an absorption characteristic of a sample, the apparatus comprising:
a microstrip waveguide comprising a ground plane, an elongate conductive strip having a first end and a second end, and a dielectric substrate separating the ground plane from the elongate strip such that the strip extends from its first end to its second end in a plane substantially parallel to the ground plane;
emitting means arranged to emit electromagnetic radiation from a first intermediate position along the microstrip waveguide, said first intermediate position being a position between the first and second ends of the strip, such that said radiation propagates along the waveguide in a direction towards the second end;
detection means arranged to detect at least one characteristic of the propagating radiation at a second intermediate position along the microstrip waveguide, the second intermediate position being a position between the first intermediate position and the second end; and
sample locating means for locating a sample at a position external to the microstrip waveguide and between the first and second intermediate positions such that at least a portion of the sample is exposed to the evanescent electric field of the propagating radiation.

This arrangement, in which the electromagnetic radiation is introduced into the microstrip waveguide and detected at intermediate positions provide the advantage that the effects of any reflections from the ends of the waveguide (i.e. the ends of the conductive strip) on the detection of one or more characteristics of the pulse that has propagated past the sample are reduced. In certain embodiments, the distances between the first end of the conductive strip and the first intermediate position, and between the second end of the conductive strip and the second intermediate position may both be made much larger (for example at least one order of magnitude larger) than the distance between the first and second intermediate positions. In certain embodiments this enables a pulse of electromagnetic radiation to be emitted from the first intermediate position and then the time-domain characteristic or characteristics of the propagating pulse to be measured at the second intermediate position over a relatively long time window before any reflections from the ends of the conductive strip can arrive at the second intermediate position and so affect detection. By enabling the time-domain characteristics of a pulse to be measured over a relatively large window, this in turn means that frequency characteristics of the detected pulse can be determined with relatively high frequency resolution.

In certain embodiments the apparatus is adapted to measure an absorption spectrum (or at least a portion of that spectrum) of a sample. Thus, certain embodiments may be described as spectroscopy apparatus.

According to a second aspect of the invention, there is provided apparatus for measuring an absorption characteristic of a sample, the apparatus comprising:
a microstrip waveguide comprising a ground plane, an elongate conductive strip having a first end and a second end, and a dielectric substrate separating the ground plane from the elongate strip such that the strip extends from its first end to its second end in a plane substantially parallel to the ground plane;
emitting means arranged to emit electromagnetic radiation from a first intermediate position along the microstrip waveguide, said first intermediate position being a position between the first and second ends of the strip, such that said radiation propagates along the waveguide in a direction towards the second end;
detection means arranged to detect at least one characteristic of the propagating radiation at a second intermediate position along the microstrip waveguide, the second intermediate position being a position between the first intermediate position and the second end; and
a sample located at a position external to the microstrip waveguide and between the first and second intermediate positions such that at least a portion of the sample is exposed to the evanescent electric field of the propagating radiation.

In certain embodiments the sample locating means is arranged to locate the sample over the conductive strip.

In certain embodiments the sample locating means comprises spacing means (e.g. one or more spacers or spacer members, or a spacing layer formed over the conducting strip) arranged to space (separate) the sample from the conductive strip. This spacing may, for example, be by a predetermined distance, a fixed distance, or may be adjustable. Preventing contact between the sample and the waveguide can be advantageous in a variety of applications.

In certain embodiments the sample locating means is adapted to locate the sample in contact with a surface of the conducting strip (which can increase interaction between the propagating radiation and the sample material as the sample is exposed to higher evanescent field).

In certain embodiments the sample locating means comprises a sample support arranged to hold the sample at said external position. The sample support may comprise adjustment means operable to adjust said external position.

In certain embodiments the sample locating means comprises sample containment means arranged to contain the sample.

In certain embodiments said external position is over said conductive strip.

The external position may be such that the sample is in contact with a surface of the conductive strip, or alternatively such that the sample is spaced from the conductive strip.

In certain embodiments the sample is a sample of crystalline or polycrystalline material.

In certain embodiments the sample is a sample of material having a vibrational absorption spectrum having at least one feature in the range 50 GHz to 100 THz, or 50 GHz to 1.5 THz for example.

In certain embodiments the sample has a volume no greater than 1 cm³ . In particular embodiments, sample volumes smaller, and indeed much smaller, than this may be used. For example, in one embodiment a sample having a volume 3×10⁻⁶ cm³ has been measured.

In certain embodiments the conductive strip has a width in the range 10 nm to 1 mm, for example 30 μm.

In certain embodiments the conductive strip has a thickness in the range 10 nm to 10 μm, e.g. 0.5 μm.

In certain embodiments the conductive strip has a length in the range 10 μm to 1 m, e.g. 15 mm, 15 cm.

In certain embodiments the distance between the first intermediate position and second intermediate position along the waveguide is in the range 1 μm to 1 m, e.g. 1.4 mm, 2.8 mm.

In certain embodiments, the distance between the first end of the conductive strip and the first intermediate position is in the range 1 μm to 1 m, e.g. 1.4 mm, 14 mm, 7 cm.

In certain embodiments the distance between the second intermediate position and the second end of the conductive strip is in the range 1 μm to 1 m, e.g. 1.4 mm, 14mm, 7 cm.

In certain embodiments, the distance between the first end of the conductive strip and the first intermediate position is greater than the distance between the first intermediate position and the second intermediate position, e.g. at least one order or magnitude greater.

In certain embodiments the distance between the second end of the conductive strip and the second intermediate position is greater than the distance between the first intermediate position and the second intermediate position, e.g. at least one order or magnitude greater.

In certain embodiments the emitting means is pulse emitting means arranged to emit a pulse of electromagnetic radiation from the first intermediate position such that said pulse propagates along the waveguide in a direction towards the second end.

The detection means may then be pulse detection means arranged to detect at least one time domain characteristic of the propagating pulse at the second intermediate position.

Certain embodiments then further comprise processing means arranged to determine at least one frequency-domain characteristic of the propagating pulse at the second intermediate position from the detected at least one time domain characteristic.

In certain embodiments the pulse is a THz pulse (i.e. a pulse of radiation, recorded in the time domain which on Fourier transformation exhibits components of frequency in the range from 50 GHz to 100 THz),

In certain embodiments the pulse emitting means comprises a first photoconductive switch illuminated by a portion of a beam from a pulsed laser.

In certain embodiments, the pulse detection means comprises a second photoconductive switch illuminated by a second portion of said beam.

In certain embodiments the pulse detection means further comprises delay means operable to apply a variable delay to the second portion of the laser beam illuminating the second photoconductive switch.

In certain embodiments, the at least one time domain characteristic comprises a voltage developed across or current developed across the second photoconductive switch as a function of time delay applied to the second portion of said beam. The processing means may then be arranged to perform a Fourier transform on voltage versus time delay data.

Certain embodiments further comprise identification means adapted to identify material in said sample from said at least one characteristic or said at least one frequency-domain characteristic.

The identification means in certain embodiments comprises a database storing data indicative of vibrational absorption spectra of a plurality of materials, and processing means arranged to compare said data with said at least one characteristic or said at least one frequency-domain characteristic.

In certain embodiments the pulse emitting means is arranged to generate a pulse of electromagnetic radiation at said first intermediate position such that the pulse propagating along the waveguide from the first intermediate position towards the second end is at least a portion of the generated pulse.

In certain embodiments the emitting means is arranged to emit electromagnetic radiation having at least one frequency component in the range 50 GHz to 100 THz. Thus, the electromagnetic radiation emitted may comprise THz radiation.

In certain embodiments the emitting means is arranged to vary the frequency of the emitted electromagnetic radiation with time. Then, the detection means may be arranged to detect a corresponding variation with time in said at least one characteristic as said frequency is varied with time. The apparatus may then further comprise identification means arranged to identify material in said sample from said detected variation. The identification means in certain embodiments comprises a database storing data indicative of vibrational absorption spectra of a plurality of materials, and processing means arranged to compare said data with said detected variation.

In certain embodiments the emitting means comprises a first photoconductive switch, and the detection means may comprise a second photoconductive switch. The emitting means in certain embodiments comprises a first laser adapted to generate a first laser beam having a first centre frequency, and a second laser adapted to generate a second laser beam having a second centre frequency, at least respective first portions of each of the first and second beams being directed so as to illuminate a common portion of the first photoconductive switch.

In certain embodiments, respective second portions of the first and second laser beams are directed so as to illuminate a common portion of the second photoconductive switch. Radiation, having been generated at the first switch and propagated through the sample, is then detected as an induced voltage or current in said second photoconductive switch.

According to a third aspect of the present invention there is provided a method for measuring an absorption characteristic of a sample, the method comprising:
providing a microstrip waveguide comprising a ground plane, an elongate conductive strip having a first end and a second end, and a dielectric substrate separating the ground plane from the elongate strip such that the strip extends from its first end to its second end in a plane substantially parallel to the ground plane;
emitting electromagnetic radiation from a first intermediate position along the microstrip waveguide, said first intermediate position being a position between the first and second ends of the strip, such that said radiation propagates along the waveguide in a direction towards the second end;
positioning a sample at a position external to the microstrip waveguide and between the first intermediate position and a second intermediate position along the microstrip waveguide, the second intermediate position being a position between the first intermediate position and the second end, such that at least a portion of the sample is exposed to the evanescent electric field of the propagating radiation; and
detecting at least one characteristic of the propagating radiation at said second intermediate position.

In certain embodiments said emitting electromagnetic radiation comprises emitting a pulse of electromagnetic radiation from said first intermediate position such that said pulse propagates along the waveguide towards the second end. The detecting may then comprise detecting at least one time-domain characteristic of the propagating pulse at the second intermediate position. The method may further comprise determining at least one frequency-domain characteristic of the propagating pulse at the second intermediate position from the detected at least one time-domain characteristic. The method may further comprise identifying material in said sample from said at least one frequency-domain characteristic.

In certain embodiments said emitting comprises varying a frequency of the emitted electromagnetic radiation with time, and said detecting comprises detecting a corresponding variation with time of said at least one characteristic. The method may then further comprise identifying a material in said sample from said detected corresponding variation.

### BRIEF DESCRIPTION OF THE DRAWINGS

Embodiments of the invention will now be described with reference to the accompanying drawings, of which:

FIG. 1 is a schematic representation of part of spectroscopy apparatus embodying the invention, with FIG. 1(a) being a perspective view and FIG. 1(b) being a cross section;

FIG. 2(a) illustrates time-domain measurements of Terahertz pulses transmitted along the microstrip line of the apparatus shown in FIG. 1;

FIG. 2(b) shows Fourier transforms of the data shown in FIG. 2(a);

FIG. 3 is a plot of data obtained using methods and apparatus embodying the invention;

FIG. 4 is a schematic representation of spectroscopy apparatus embodying the invention;

FIG. 5 is a schematic plan view of part of the apparatus shown in FIG. 1;

FIG. 6 is a schematic representation of part of spectroscopy apparatus embodying the invention;

FIG. 7 is a schematic representation of a microstrip waveguide, sample, and sample support in apparatus and methods embodying the invention;

FIG. 8 is a schematic representation of another microstrip waveguide and sample arranged in another embodiment of the invention;

FIG. 9 is a schematic representation of yet another microstrip waveguide and sample in apparatus and methods embodying the invention;

FIG. 10 is a schematic representation of spectroscopy apparatus in accordance with another embodiment of the invention; and

FIG. 11 is a schematic representation of apparatus for use in embodiments of the invention, and comprising two lasers for producing Terahertz radiation.

### DETAILED DESCRIPTION OF EMBODIMENTS OF THE INVENTION

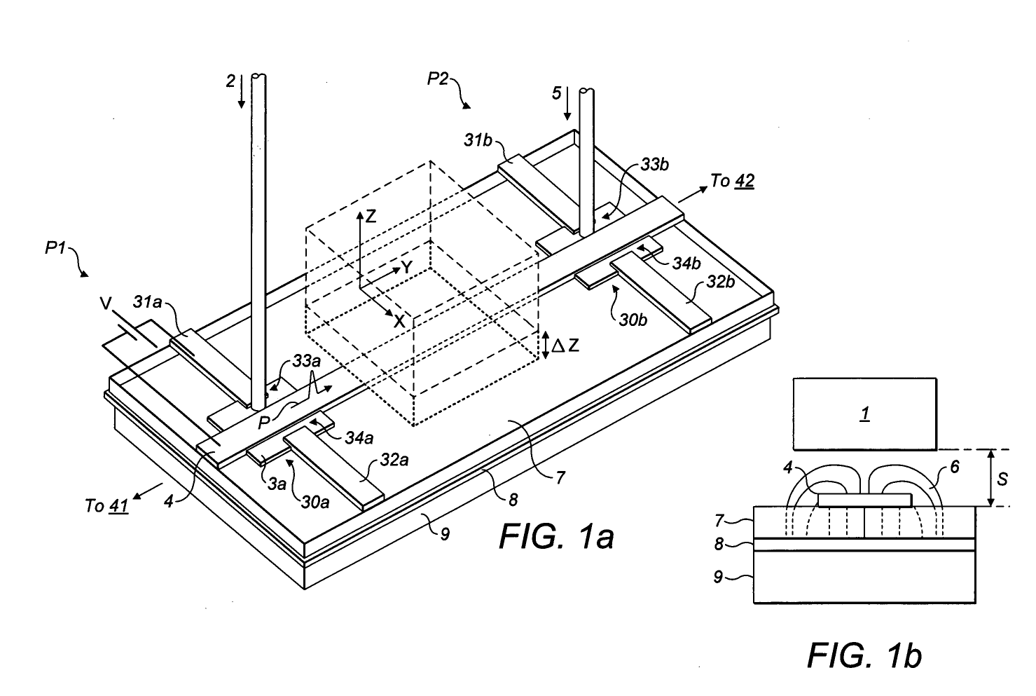

A first embodiment of the invention will now be described with reference to FIGS. 1 to 6.

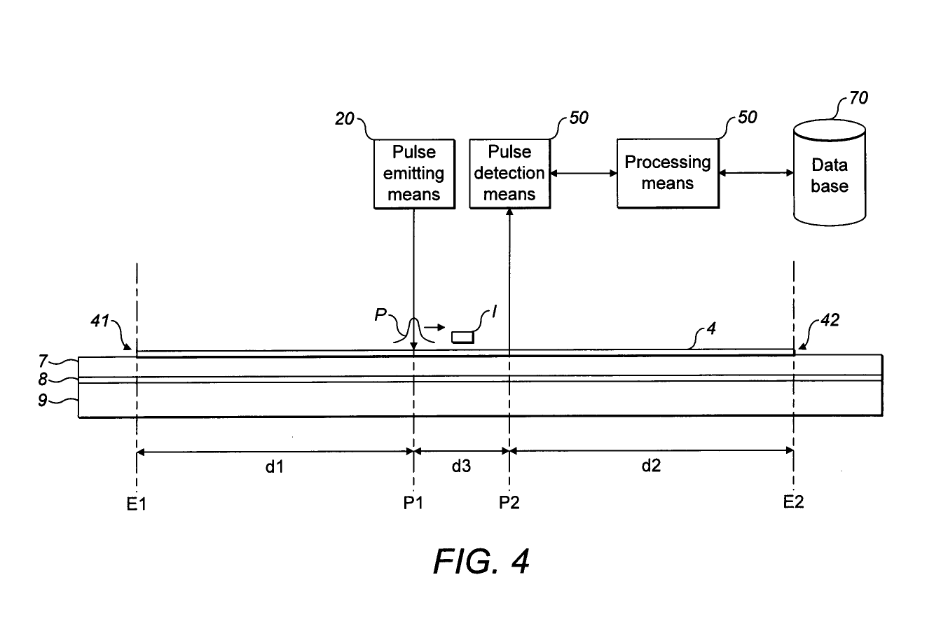

In this first embodiment, apparatus for measuring the absorption spectrum of a sample 1 comprises a microstrip waveguide (formed on a single chip). The microstrip waveguide comprises a ground plane 8 supported on an underlying substrate 9. The waveguide also comprises an elongate conductive strip 4 or microstrip, having a first end 41 and a second end 42. The waveguide also comprises a dielectric substrate 7 (which in this example is substantially transparent to Terahertz radiation) separating the ground plane 8 from the elongate strip 4 such that the strip and ground plane are spaced apart by a substantially uniform distance along the length of the strip. The full length of the microstrip waveguide is shown in FIG. 4, but in FIG. 1(a) only a central portion of the waveguide is shown for clarity (as it enables details of the electromagnetic radiation emitting and detecting means to be shown in more detail). Referring again to FIG. 4, the apparatus comprises pulse emitting means 20 arranged to emit a pulse P of electromagnetic radiation from a first intermediate position P1 along the microstrip waveguide. The first intermediate position is a position between the first and second ends 41, 42. The pulse P propagates along the waveguide in a direction towards the second end 42. The apparatus also comprises pulse detection means 50 arranged to detect at least one time-domain characteristic of the propagating pulse P at a second intermediate position P2 along the waveguide, this second intermediate position being a position between the first intermediate position and the second end 42.

A sample 1 of material is located over the waveguide (in particular over the conductive strip 4) at a position between P1 and P2 such that as the pulse P propagates past the sample, the sample (or at least part of it) is exposed to the evanescent electrical field of the propagating pulse P. The propagating pulse in turn is affected by the sample in close proximity to the waveguide and the pulse detection means 50 is arranged to detect the resultant effect. In particular, when the pulse P is a Terahertz pulse of radiation, and the sample has at least one absorption characteristic in the Terahertz range, when the pulse arriving at position P2 is detected and analysed it may show a notch or other such feature in its energy versus frequency characteristics, that notch corresponding to absorption of frequency components at the or each Terahertz vibrational resonance in the sample. In the arrangement of FIG. 4, the pulse detection means 50 is arranged to measure a time-domain characteristic of the pulse that has propagated past the sample 1. It will be appreciated that this can be achieved in a variety of ways in certain embodiments of the invention, and may, for example, give data representing the variation of a voltage or electric field with time, or indeed a current with time. The apparatus also comprises processing means 60 which takes the time-domain characteristic data from the pulse detection means and performs a Fourier transform to determine a corresponding frequency characteristic of the pulse arriving at position P2. In this frequency characteristic, absorption features can thus be detected, those features corresponding to vibrational resonances of the sample 1. The apparatus also comprises a database 70 which stores data indicative of the vibrational absorption spectra of a plurality of materials. The processing means in the range to compare the data from the database 70 with the absorption data derives by performing the Fourier transform on the time-domain data. The processing means is thereby able to identify the presence of any materials from the database that are present in the sample 1. In the arrangement of FIG. 4, the distance D3 between the first intermediate position P1 and second intermediate position P2 is much smaller than the distance D1 between the position of the first end 41 of the strip and P1, and the position E2 of the second end of the strip 42 and P2. The pulse detection means is arranged to measure the time domain characteristic of the received pulse over a time window selected so that it is short enough that reflections from ends 41 and 42 cannot arrive back at the second intermediate position P2 in time to affect the measurements. In certain embodiments, distance D3 is in the range 1 to 5 mm, and distances D1 and D2 may each be in the range of 5 to 15 cms. In one particular embodiment, for example, distance D3 is approximately 3 mm, and distances D1 and D2 are each in excess of 7 cms, with a total length of the conductive strip 4 (and hence waveguide) being approximately 15 cms.

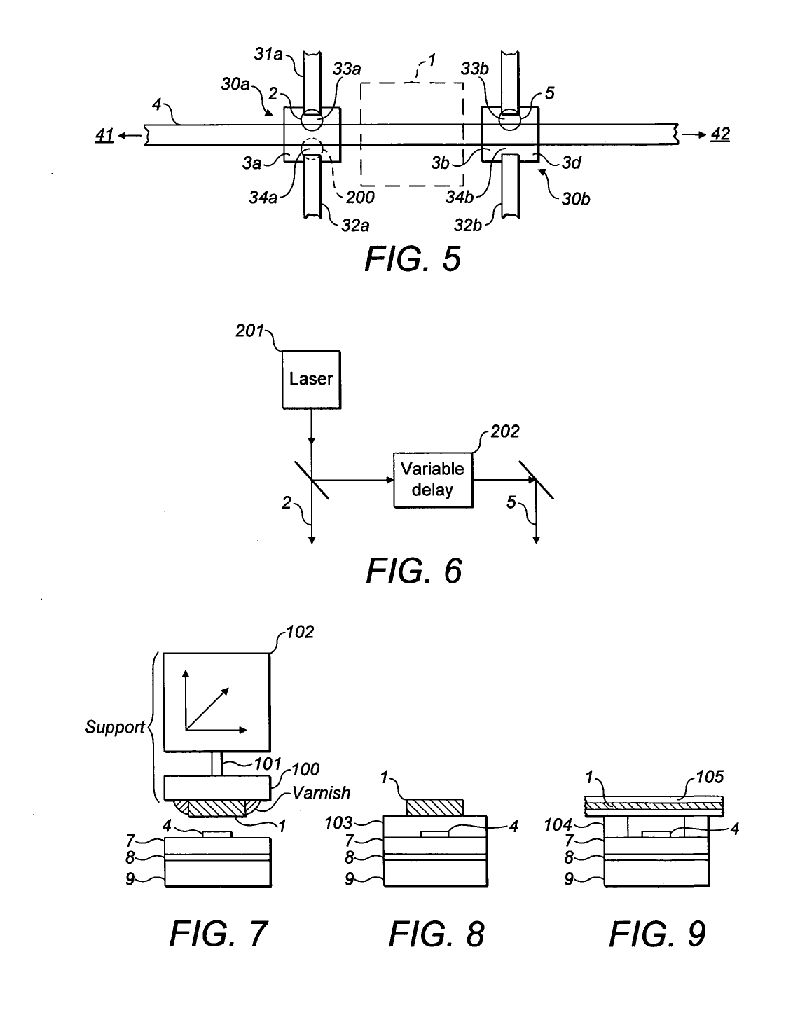

Referring in particular now to FIG. 1, this shows part of the apparatus of FIG. 4 in more detail. Just a central portion of the on-chip waveguide is shown in the perspective view of FIG. 1(a), that central portion being the portion over which the sample 1 is located. The pulse emitting means 20 is arranged to generate and emit the pulse B along the waveguide at position P1. The pulse emitting means comprises a first photoconductive switch 30a having a structure generally as described in reference [5] below, the contents of which are hereby incorporated by reference. The photoconductive switch 30a comprises a pad 3a of a photoconductive semiconductor such as low-temperature-grown gallium arsenide (LTGaAs) formed on the substrate 7 either above or beneath the conductive strip 4. The switch 38 also comprises further conductive strips 31a and 32a which each extend transversely from the pad 3a in a direction substantially perpendicular to the longitudinal direction of the strip 4. Gaps 33a and 34a are defined between the ends of the strips 31a and 32a and the sides of the central conductive strip of the waveguide 4 respectively. The pulse emitting means then comprises a pulsed laser beam 2 arranged to illuminate just one of those gaps, in particular gap 33a. A bias voltage V is applied between the conductive strip 31a and the central conductive strip 4. The combined effect of the applied bias voltage and the pulse laser incident on the gap 33a is that a pulse of Terahertz radiation P is generated and emitted along the waveguide, from position P1 in a direction towards the second intermediate position P2. The pulse detection means comprises a second photoconductive switch 30b having substantially the same construction as the first switch 30a. Again, respective gaps 33b and 34b are defined between ends of conductive strips 31b and 32b and the waveguide conductive strip 4. For detection purposes, another pulsed laser beam 5 is directed onto gap 33b. Beams 2 and 5 are in fact portions of a single laser beam from a single laser source. However, the portion providing beam 5 has been delayed by suitable means. In order to measure time-domain characteristics of the pulse P arriving at position P2 the delay is varied (or scanned) with time. FIG. 6 shows, in highly schematic form, apparatus for deriving beams 2 and 5 in a certain embodiment of the invention. As can be seen, the apparatus includes variable delay means 202 for controlling the delay between the pulses applied to gap 33a and those applied to gap 33b. Referring to FIG. 5, this shows in some more detail the positioning of laser beams 2 and 5 over gaps 33a and 33b respectively. In certain embodiments, it is not necessary to measure any characteristics of the pulse P generated at the first photoconductive switch 30a, instead just characteristics of the pulse arriving at the second intermediate position P2 are measured by means of the pulsed laser 5 illuminating the gap 33b. However, in alternative embodiments, it may be desirable to measure characteristics of the generated pulse B, and this can be done by positioning a further pulsed laser beam 200 over gap 34a. Further details of how to measure pulse characteristics using the photoconductive switch arrangement illustrated in FIGS. 1 and 5 will be appreciated by those skilled in the art, and so will not be described in any more detail here. Looking at FIG. 1, the sample 1 is generally cuboid in this example, and is positioned over the strip 4. In certain embodiments, as will be described in further detail below, its height or separation above the strip 4 may be varied, and this affects the degree of interaction between the pulse P and the sample material, and indeed the influence of the sample on the characteristics of the pulse arriving at position P2. Though a cuboid sample is represented in FIG. 1, it is to be noted that any three-dimensional solid shape of sample including spheres, hemispheres, cylinders, and combinations therefore, could be used.

The apparatus of FIGS. 1-6 and its use in methods embodying the invention will now be described in further detail.

The following description, with reference to FIGS. 1 to 3 in particular, can be regarded as a description of terahertz vibrational absorption spectroscopy using microstrip-line waveguides.

FIG. 1 is a schematic diagram of lactose monohydrate samples (1) being monitored using an on-chip THz microstrip system. A ˜12 fs duration, 800 nm laser beam, with a repetition rate of 80 MHz, (2) is focused on a biased (40 V) photoconductive LT-GaAs switch (3a). The terahertz pulses generated by photoconduction are coupled directly into an adjacent Au microstrip line (4), where they propagate as ˜picosecond duration electrical pulses. The time-domain amplitude of the electrical transients is sampled by a time-delayed portion of the femtosecond laser beam (5) focused on a second integrated photoconductive switch 3b. The inset (FIG. 1(b)) is cross-sectional view of the microstrip line, showing the pattern of electric field associated with the current pulses propagating on the microstrip. The evanescent field 6 extending above the microstrip penetrates the lactose sample held above the microstrip, and records its absorption spectra. Under the microstrip signal conductor, a benzocyclobutene (BCB) dielectric layer (7) overlays a Ti:Au backplane (8), formed on a Si wafer (9). It should be noted that other dielectric layers with a suitably low permittivity and/or attenuation constant could be used in place of BCB; examples of the latter include other polymeric materials such as Kapton, as well as plastics.

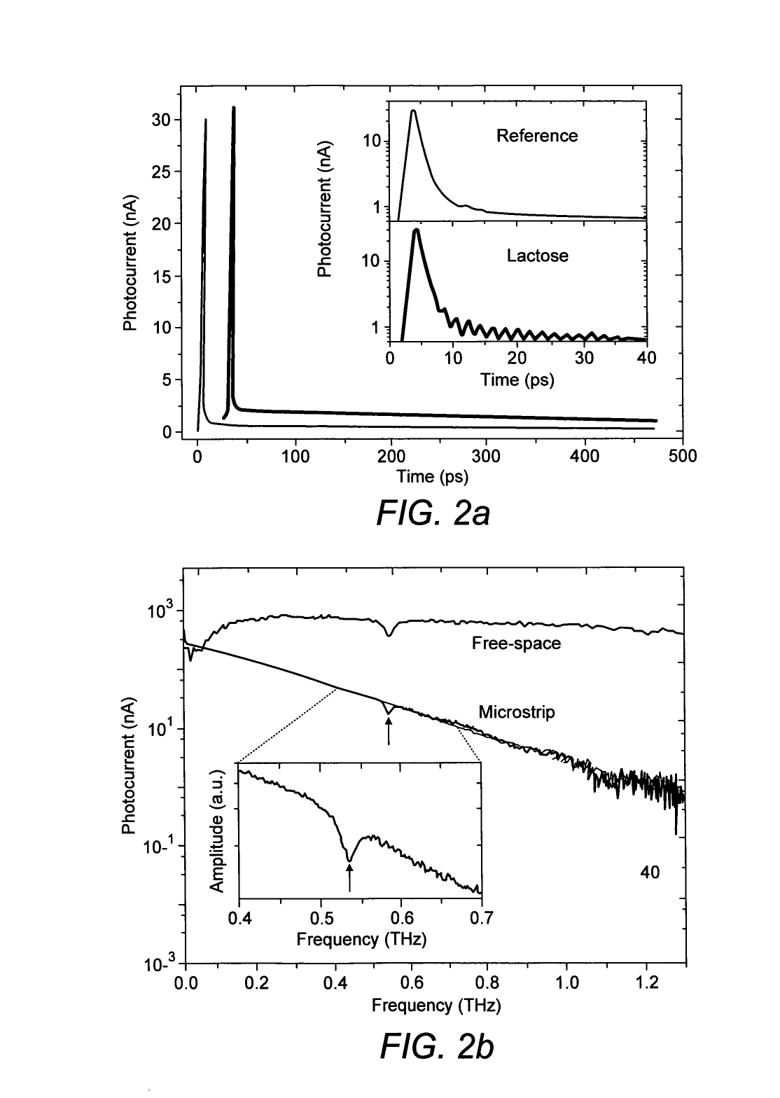

FIG. 2: a) shows time-domain measurements of terahertz pulses transmitted along the microstrip line, over a 470 ps time-window, to yield a frequency resolution of 2 GHz in the Fourier transform. Bold lines indicate data obtained after contacting the lactose sample with the microstrip. Data are horizontally and vertically offset for clarity. The inset in FIG. 2(a) shows pulsed data over a shorter time-window, highlighting the ringing indicative of frequency-specific absorption in the lactose sample.

FIG. 2 (b) shows Fourier transforms of the data shown in 2(a), along with free-space transmission data for comparison. The absorption resonance at 534 GHz is indicated by arrows.

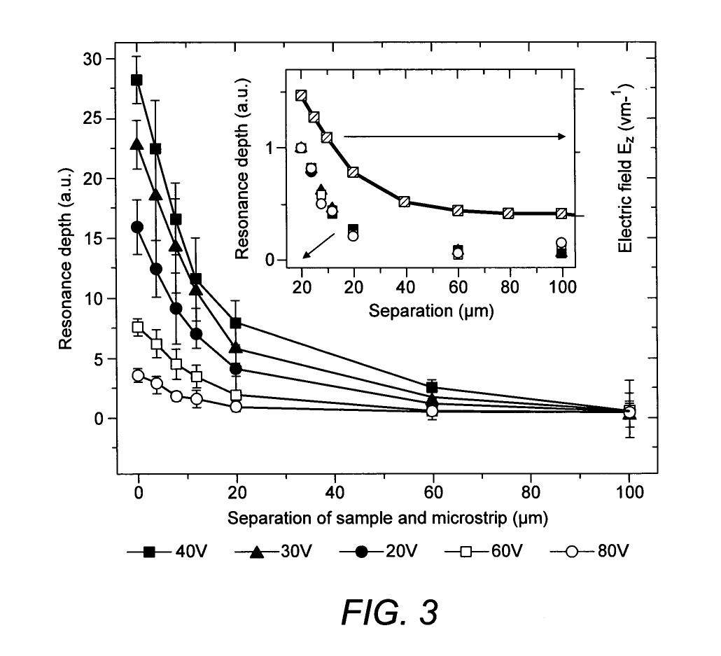

FIG. 3: presents data showing the 534 GHz vibrational resonance depth (defined as the maximum deviation of the amplitude of the frequency domain spectra, at the centre of the resonance, from a reference trace taken with no sample present) as a function of the separation between the microstrip and lactose sample, measured for a range of bias voltages on the photoconductive emitter switch. The trend to larger resonance depths for larger bias voltages is attributed to the increased current density on the microstrip line induced by the larger-amplitude terahertz pulses. The inset to FIG. 3 shows resonant depth of the data for all values of voltage, normalized to show collapse of the data onto a single curve, along with 3D electromagnetic simulation results showing, the normalized instantaneous maximum value of the transverse electric field E_{Z} above the centre of the microstrip. All lines are guides to the eye.

The following description (with reference to FIGS. 1-3) demonstrates that on-chip terahertz microstrip-line waveguides can be used to record vibrational absorption spectra of polycrystalline materials, with a high (˜2 GHz) frequency resolution, and lithographically-defined spatial resolution. Microstrip-guided, terahertz-bandwidth electromagnetic pulses interact with overlaid samples via the evanescent electric field extending above the propagating surface current. The interaction causes the evanescent electric field to pick up characteristic spectral features corresponding to vibrational absorption resonances in the sample. To demonstrate the technique, the terahertz absorption spectrum of lactose monohydrate was investigated; the lowest lying mode was found to occur at 534 (±2) GHz, in excellent agreement with free-space measurements. The technique offers a higher spatial and frequency resolution than free-space terahertz time-domain spectroscopy, requires no contact between the waveguide and sample, and demonstrates the potential of on-chip terahertz circuits for monitoring and identifying polycrystalline materials.

This description demonstrates the potential for lithographically defined on-chip microstrip waveguides with integrated THz pulse emitters and detections to record the broadband terahertz absorption spectra of polycrystalline materials. This technique affords significant advantages compared with the prior art methodologies; the enhanced concentration of the propagating terahertz electric field allows much smaller volumes to be analyzed, and the frequency resolution of the Fourier transformed pulsed data is enhanced, since the sampled time-windows is determined solely by lithographic considerations. The penetration of a propagating terahertz evanescent field above a microstrip penetrates dielectric samples held in close proximity, causing the propagating electric field to pick up spectral features corresponding to vibrational modes of the sample, which are revealed by a Fourier transform of the detected time-domain signals. In embodiments of the invention, microstrip lines were fabricated using a 25/250 nm-thick Ti/Au microstrip line 4, on a 6 μm-thick benzocyclobutene (BCB) dielectric layer 7, itself formed on a 25/500 nm Ti/Au coated Si wafer, which was used as a backplane 9,8 (see FIG. 1). Integrated photoconductive switches 30a, 30b for terahertz-bandwidth signal excitation and detection were etched from low-temperature-grown gallium arsenide (LT-GaAs, 350 nm), grown by molecular beam epitaxy on a sacrificial 100-nm-thick AlAs layer, itself grown on a GaAs substrate. Epitaxial lift-off of 350-nm-thick LT-GaAs layers from their growth substrate was achieved using dilute hydrofluoric acid (10%) to selectively remove the AlAs layer, before transfer of the LT-GaAs onto BCB using black wax as a support [5, 6].

The width of the microstrip-line chosen was 30 μm, with pulses transmitted over a 2.8 mm-long ‘active’ length of microstrip between the LT-GaAs emitter and detector (i.e. d3=2.8 mm in this example). A significant advantage of this on-chip technique is that it allows us to remove the signal reflections which can limit frequency resolution in other THz spectroscopy systems. The ‘parasitic’ length of the microstrip 4 beyond each switch region 30a, 30b was maximised (and only limited by lithographical yield considerations) in order to delay the reflections of the main transmitted terahertz pulse P, so producing a longer reflection-free time-window, and therefore higher frequency resolution Fourier transform. The total length of the microstrip line chosen was 15 cm, as a compromise between device yield (given the extreme 5000:1 length to width aspect ratio of the microstrip signal conductor so formed), and the required frequency resolution. Measurements were performed using a pulsed generation and detection scheme; a ˜15 mW ˜12 fs pulse duration Ti:sapphire laser 2 was used to illuminate the biased (at 40 V) LT-GaAs switch region 33a for pulse emission, and a ˜15 mW beam-split and time-delayed portion of the beam 5 focussed on to the second LT-GaAs switch 30b for signal detection [5]. THz pulses were measured at the detection switch over a typical time window of 470 ps (FIG. 2a), over which no signal reflection occurred, yielding a frequency resolution of 2 GHz after Fourier transformation of the pulsed data.

Samples of lactose monohydrate (Sigma-Aldrich) were compressed into pellets, and then diced into 1×1×0.5 mm samples 1. These were mounted on a brass holder using a hard-setting varnish, itself attached to a 3-axis linear translation stage (Ocean Optics), to control their relative position to the microstrip; all samples were mounted in plane-parallel contact with the microstrip line, in order to maximise their interaction with the microstrip. Measurements were first undertaken with samples in full contact with the microstrip. All samples measured (5 in total) showed a clear absorption resonance at 534 (±2) GHz (FIG. 2b). The absorption resonance is also evident in the corresponding time-domain terahertz signal (inset to FIG. 2a), as a train of oscillations in the pulse-tail.

The frequency position of the 534 GHz absorption resonance was confirmed by direct comparison with spectra recorded in a free-space THz-TDS system (see FIG. 2c), and also agrees well with prior experimental data undertaken using a range of techniques [3, 7, 8]. The microscopic molecular motion responsible for this mode has recently been the subject of detailed periodic Density Functional Theory calculations [9, 10], in which works the mode is attributed to a hindered external rotational mode (rather than an internal molecular mode), with an unusually long lifetime (and therefore sharp resonance in the frequency domain). A Lorentzian fit to the absorption feature we observe using the on-chip system shows a FWHM of 22 (±4) GHz, with an equivalent damping period τ=(π FWHM)⁻¹ of ˜14 ps, in excellent agreement with data obtained in Ref. 7 using a cw frequency-multiplier-chain source.

Further experiments were undertaken to demonstrate that samples do not have to be in direct contact with the microstrip-line for the absorption resonances to be recorded in the propagating current pulse, but merely within the region of evanescent field; this could be important in potential applications such as monitoring of pharmaceuticals, for example, where repeated contact could induce circuit failure. The X/Y/Z translation stage 102 was used to vary the separation s of the microstrip and lactose sample over the range 0 μm (full contact) to 200 μm (outside the region of evanescent field, as determined by simulations undertaken using high-frequency electromagnetic solving software).

The depth of the vibrational resonance rapidly reduced as the sample-to-microstrip distance was increased, disappearing into the noise floor for separations >100 μm (FIG. 3). Variation of the bias voltage applied to the emitter photoconductive switch controlled the propagating pulse amplitude, and depth of the absorption resonance measured (FIG. 3); the bias controls the propagating current density, and therefore the intensity and extent of the evanescent field extending above the microstrip-line. The data from all voltages collapse onto a single curve when normalised to the absorption depth observed under conditions of full contact with the waveguide (FIG. 3 inset).

A numerical full 3D frequency-dependent electromagnetic simulation of the system (undertaken using the Ansoft high-frequency structure simulator) provided calculations of the instantaneous electric field strength at arbitrary positions around the microstrip waveguide. The functional form of the maximum instantaneous value of electric field intensity at the resonant absorption frequency (534 GHz) at the sample location was found to correspond well with the observed decay of the resonance (FIG. 3). Such simulations also provided a means to estimate the volume of electric field interacting with the sample; a volume of ˜3.5×10⁻¹² m³ above the microstrip was found to enclose 95% of the electric field density for the present geometry and samples, which is around two orders-of-magnitude smaller than the volume sampled by a typical diffraction limited THz-TDS system (assuming a diffraction-limited circular THz focus of diameter 1 mm). The frequency resolution (˜2 GHz) of our spectral measurements are also over three times smaller than that recently reported for parallel plate waveguide systems [4].

Thus, apparatus and methods embodying the invention have demonstrated the capability of planar microstrip circuits to resolve narrow spectral features of polycrystalline materials in the terahertz frequency range. The broadband spectrum of polycrystalline lactose monohydrate was measured using terahertz microstrip-line over a frequency range 0.1-0.8 THz, with an unprecedented frequency resolution for pulsed techniques of 2 GHz.

Referring now to FIG. 7, this is a highly schematic view of part of spectroscopy apparatus embodying the invention. Again, the apparatus comprises a microstrip waveguide with the conductive strip 4 separated from the ground plane 8 by a dielectric layer 7. In this embodiment, the sample 1 is fixed to a support. In particular, the support comprises a moveable support head 100 to which the sample 1 is attached using varnish. The support comprises an actuator 102 (which may also be referred to as actuating means, or a moveable support stage) which is coupled to the support head 100 by a rigid coupling 101. The actuator 102 can be controlled to adjust the position of the sample 1 relative to the conductive strip 4 in any one of three dimensions. Thus, the support as a whole can be controlled to adjust the separation of the lower sample surface in the figure and the upper surface of the conductive strip 4. It may be adjusted to give a desired separation, or indeed to bring the sample 1 into contact with the strip 4. In general, the position of the sample 1 may thus be adjusted with respect to the waveguide so as to maximise or optimise the interaction between radiation propagating along the waveguide and the sample.

Moving on to FIG. 8, here the apparatus further comprises a dielectric spacer layer 103 which is formed on the dielectric substrate 7, over the conductive strip 4. In other words, the spacer layer 103 encapsulates the conductive strip 4. The spacer layer 103 has been arranged so as to have a desired thickness, and the sample 1 is shown located directly on top of the spacer layer. Thus, the spacer layer prevents physical contact between the sample and the underlying waveguide. Such an arrangement can be useful in a variety of applications, for example in the testing of samples where repeated direct contact between the sample material and the conductive strip could degrade the microstrip waveguide itself, or in which the microstrip waveguide material could contaminate the sample 1.

Moving on to FIG. 9, this shows an alternative arrangement in certain embodiments of the invention in which the sample 1 is in the form of a liquid contained in a sample container 105. In this example the sample container is a capillary tube. Spacers 104 are arranged (in this example on top of the substrate surface 7) to separate the sample 1 from the conductive strip 4 of the waveguide by a predetermined amount. In this example the spacers 104 are in direct contact with the capillary tube outer wall and the substrate 7. It will be appreciated that in alternative embodiments different forms of one or more spacers may be used, and indeed the sample container may have a form other than a capillary tube.

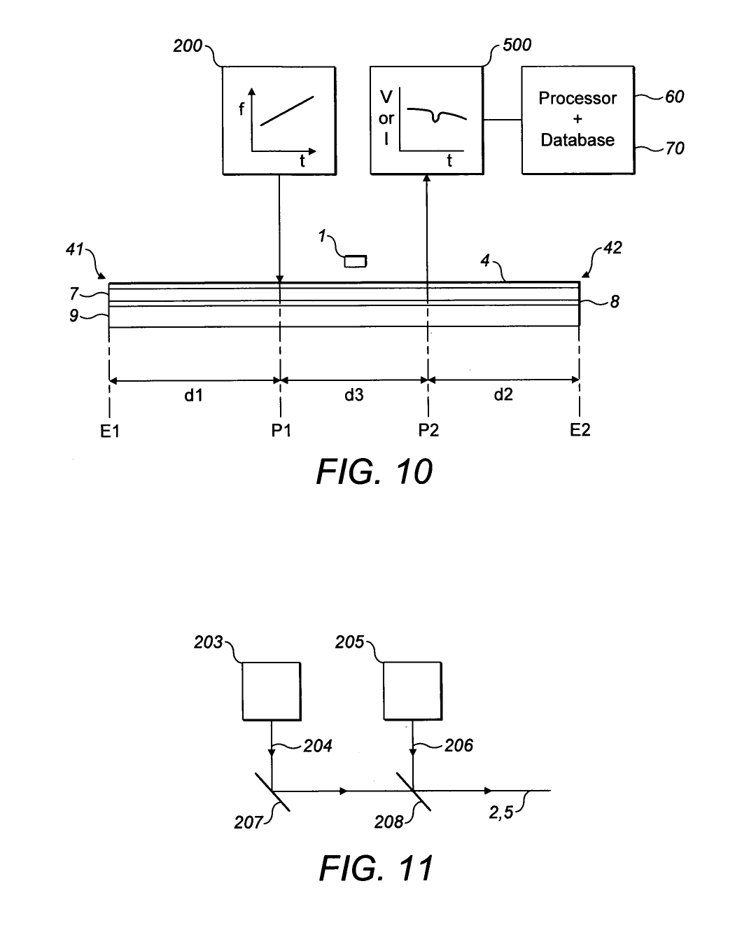

Moving on to FIG. 10, this is a schematic view of spectroscopy apparatus in accordance with another embodiment of the invention. The apparatus again comprises an elongate microstrip waveguide, having a conductive microstrip 42 separated from a ground plane 8 by a dielectric layer 7. The ground plane is supported by a support layer 9. The apparatus comprises emitting means 200 arranged to emit electromagnetic radiation from a first intermediate position P1 into and along the waveguide in a direction towards the second intermediate position P2. In this example, the emitting means does not emit a pulse of radiation. Instead, the emitting means is arranged such that at a particular time it emits electromagnetic radiation having substantially a single frequency (or in other words it emits electromagnetic radiation having a very narrow bandwidth. However, the emitting means is also arranged such that this wavelength (and hence the corresponding frequency of the emitted electromagnetic radiation) can be varied with time. In this particular embodiment, the emitting means is arranged to scan the frequency of the radiation it emits with time. Again, a sample 1 is positioned proximate the microstrip 4, between positions P1 and P2. Detection means 500 is arranged to detect a characteristic of the propagating electromagnetic radiation at position P2. For example, the detecting means may be arranged to detect a voltage, electric field, or current associated with the propagating electromagnetic radiation as a function of time as the frequency of the injected radiation is scanned with time by the emitting means 200. The detecting means 500 is thus able to spot notches or other such features in the detected V/E/I characteristics versus time, those notches corresponding to absorption resonances of the sample material. The apparatus further comprises computing means comprising a processor 60 and database 70, the database holding data on the absorption spectra of a plurality of materials. The computing means is connected to the detecting means 500 and is arranged to compare known absorption spectra from its library with the data obtained by the detecting means 500 and so identify a material or materials present in the sample 1.

In certain embodiments, the emitting means 200 and detection means 500 may each comprise a photoconductive switch of the type illustrated and described above with respect to FIG. 1(a). However, in order to inject radiation at a particular wavelength or frequency into the microstrip waveguide rather than injecting a pulse, the gaps of the emitting and detecting photoconductive switch are not illuminated with pulsed laser beams. Instead two continuous lasers are used simultaneously to generate Terahertz radiation at the switch locations. In particular, two continuous-wave laser beams of different frequency are mixed together to generate a continuous-wave Terahertz signal at the difference frequency at the emitting switch. The two different laser beams are also mixed together at the second, detecting switch for detection. The photomixing technique is described in further detail in the paper (analysis of photomixer receivers for continuous-wave Terahertz radiation), Applied Physics Letters 91, 154103 [2007], the contents of which are hereby incorporated by reference. In the described photomixing principle, the frequency difference between two lasers is tuned to the Terahertz region, and the optical beat used to modulate the conductance of a biased semi-conductor switch (photomixer emitter). Monochromatic Terahertz radiation is emitted at said beat frequency. If the laser beat is also used to modulate the conductivity of a photomixer receiver, then the Terahertz beam is detected coherently. Tuning over a range of Terahertz frequencies is achieved using frequency tunable lasers. Thus, in certain embodiments of the invention employing this photomixing principle, an arrangement of two lasers 203, 205 can be used as shown in FIG. 11. Here, the first laser 203 emits a laser beam 204 having a first centre frequency, and the second laser 205 emits a laser beam 206 having a second, different centre frequency. The two beams 204, 206 are combined by suitable means 207, 208 to form a single beam which can be used to illuminate the gap 33a at an emitter photoconductor switch, or the gap 33b at the detector photoconductive switch. One or both of the lasers 203, 205 is tunable such that the difference frequency can be varied with time. This in turn can be used to scan the frequency of Terahertz radiation injected into the waveguide at the first intermediate position P1.

The emission and detection of the electromagnetic radiation at respective intermediate positions again provides advantages. The distances from P1 and P2 to the respective ends 41 and 42 can be made large enough so that any radiation reflected from them is greatly attenuated by the time it reaches P1 and P2, and hence does not appreciably affect the detection/measurements of characteristics by the detection means.

From the above, it will be appreciated that certain embodiments of the invention provide Terahertz frequency spectroscopy apparatus and methods which may be used in the detection of a wide variety of materials for a wide variety of applications.

Particular applications of the described apparatus and methods include: the detection of explosives; the detection of drug-of-abuse; monitoring the purity, formation, or chemical reactions within pharmaceutical materials; monitoring the properties of pharmaceutical materials through packaging materials (for example, through capsules coatings or containers); distinguishing between and monitoring the transition between different polymorphic forms of organic compounds, including pharmaceutical materials; monitoring the dielectric properties of biological molecules such as proteins or DNA, either in crystalline form, aqueous solution, or dried; monitoring the binding or hybridisation state of biological molecules such as DNA or proteins; monitoring the dielectric or conductive properties of semiconductors; monitoring the dielectric properties of biological cells or tissues; monitoring the dielectric or conductive properties of organic semiconductors; process monitoring in industrial applications.

The references appearing in the above text [each in square brackets] are as follows, and the contents of each document are hereby incorporated in this document by reference:

[1] W. H. Fan, A. D. Burnett, P. Upadhya, J. Cunningham, E. H. Linfield and A. G. Davies, Appl. Spectroscopy 61, 638 (2007).

[2] M. Walther, M. Freeman and F. A. Hegmann, Appl. Phys. Lett. 87, 261107 (2005).

[3] J. S. Melinger, N. Laman, S. Sree Harsha, and D. Grishcowsky, Appl. Phys. Lett. 89, 251110 (2006)

[4] N. Laman, S. S. Harsha, D. Grischkowsky, and J. S. Melinger, Optics Express 16, 4094 (2008).

[5] J. Cunningham, C. D. Wood, A. G. Davies, I. C. Hunter, E. H. Linfield and H. E. Beere, Appl. Phys. Lett. 86, 213503 (2005).

[6] M. Nagel, P. Haring Bolivar, M. Brucherseifer and H. Kurtz, Applied Physics Letters 80, 154, (2002).

[7] E. R. Brown, J. E. Bjarnason, A. M. Fedor, and T. M. Korter, Appl. Phys. Lett. 90, 061908 (2007).

[8] E. R. Brown, E. B. Brown, D. L. Woolard, Proc. IRMMW-THz, 928 (2007).

[9] D. G. Allis, A. M. Fedor, T. M. Korter, J. E. Bjarnason, E. R. Brown, Chem. Phys. Lett. 440, 203 (2007).

[10] S. Saito, T. Inerbaev, H. Mizuseki, N. Igarashi, R. Note, and Y. Kawazoe, Jap. J. Appl. Phys. 45, L1156 (2006).

1. Apparatus for measuring an absorption characteristic of a sample, the apparatus comprising:
a microstrip waveguide comprising a ground plane, an elongate conductive strip having a first end and a second end, and a dielectric substrate separating the ground plane from the elongate strip such that the strip extends from its first end to its second end in a plane substantially parallel to the ground plane;
emitting means arranged to emit electromagnetic radiation from a first intermediate position along the microstrip waveguide, said first intermediate position being a position between the first and second ends of the strip, such that said radiation propagates along the waveguide in a direction towards the second end;
detection means arranged to detect at least one characteristic of the propagating radiation at a second intermediate position along the microstrip waveguide, the second intermediate position being a position between the first intermediate position and the second end; and
sample locating means for locating a sample at a position external to the microstrip waveguide and between the first and second intermediate positions such that at least a portion of the sample is exposed to the evanescent electric field of the propagating radiation.

2. Apparatus for measuring an absorption characteristic of a sample, the apparatus comprising:
a microstrip waveguide comprising a ground plane, an elongate conductive strip having a first end and a second end, and a dielectric substrate separating the ground plane from the elongate strip such that the strip extends from its first end to its second end in a plane substantially parallel to the ground plane;
emitting means arranged to emit electromagnetic radiation from a first intermediate position along the microstrip waveguide, said first intermediate position being a position between the first and second ends of the strip, such that said radiation propagates along the waveguide in a direction towards the second end;
detection means arranged to detect at least one characteristic of the propagating radiation at a second intermediate position along the microstrip waveguide, the second intermediate position being a position between the first intermediate position and the second end; and
a sample located at a position external to the microstrip waveguide and between the first and second intermediate positions such that at least a portion of the sample is exposed to the evanescent electric field of the propagating radiation.

3.-5. (canceled)

6. Apparatus in accordance with claim 1, wherein the sample locating means comprises a sample support arranged to hold the sample at said external position.

7. Apparatus in accordance with claim 6, wherein the sample support comprises adjustment means operable to adjust said external position.

8.-20. (canceled)

21. Apparatus in accordance with claim 1, wherein the distance between the first end of the conductive strip and the first intermediate position is greater than the distance between the first intermediate position and the second intermediate position.

22. Apparatus in accordance with claim 21, wherein the distance between the first end of the conductive strip and the first intermediate position is greater than the distance between the first intermediate position and the second intermediate position by at least one order of magnitude.

23. Apparatus in accordance with claim 1, wherein the distance between the second end of the conductive strip and the second intermediate position is greater than the distance between the first intermediate position and the second intermediate position.

24. Apparatus in accordance with claim 23, wherein the distance between the second end and the second intermediate position is greater than the distance between the first and second intermediate positions by at least one order of magnitude.

25. Apparatus in accordance with claim 1, wherein the emitting means is pulse emitting means arranged to emit a pulse of electromagnetic radiation from the first intermediate position such that said pulse propagates along the waveguide in a direction towards the second end.

26. Apparatus in accordance with claim 25, wherein the detection means is pulse detection means arranged to detect at least one time domain characteristic of the propagating pulse at the second intermediate position.

27. Apparatus in accordance with claim 26, further comprising processing means arranged to determine at least one frequency-domain characteristic of the propagating pulse at the second intermediate position from the detected at least one time domain characteristic.

28. Apparatus in accordance with claim 25, wherein said pulse is a THz pulse.

29. -33. (canceled)

34. Apparatus in accordance with claim 1, further comprising identification means adapted to identify material in said sample from said at least one characteristic.

35. (canceled)

36. Apparatus in accordance with claim 34, wherein said identification means comprises a database storing data indicative of vibrational absorption spectra of a plurality of materials, and processing means arranged to compare said data with said at least one characteristic.

37. Apparatus in accordance with claim 25, wherein said pulse emitting means is arranged to generate a pulse of electromagnetic radiation at said first intermediate position such that the pulse propagating along the waveguide from the first intermediate position towards the second end is at least a portion of the generated pulse.

38.-39. (canceled)

40. Apparatus in accordance with claim 1, wherein the emitting means is arranged to vary a frequency of the emitted electromagnetic radiation with time.

41. Apparatus in accordance with claim 40, wherein the detection means is arranged to detect a corresponding variation with time in said at least one characteristic as said frequency is varied with time.

42. Apparatus in accordance with claim 41, further comprising identification means arranged to identify material in said sample from said detected variation.

43. Apparatus in accordance with claim 42, wherein said identification means comprises a database storing data indicative of vibrational absorption spectra of a plurality of materials, and processing means arranged to compare said data with said detected variation.

44.-47. (canceled)

48. A method for measuring an absorption characteristic of a sample, the method comprising: providing a microstrip waveguide comprising a ground plane, an elongate conductive strip having a first end and a second end, and a dielectric substrate separating the ground plane from the , elongate strip such that the strip extends from its first end to its second end in a plane substantially parallel to the ground plane; emitting electromagnetic radiation from a first intermediate position along the microstrip waveguide, said first intermediate position being a position between the first and second ends of the strip, such that said radiation propagates along the waveguide in a direction towards the second end; positioning a sample at a position external to the microstrip waveguide and between the first intermediate position and a second intermediate position along the microstrip waveguide, the second intermediate position being a position between the first intermediate position and the second end, such that at least a portion of the sample is exposed to the evanescent electric field of the propagating radiation; and detecting at least one characteristic of the propagating radiation at said second intermediate position.

49. -56. (canceled)
